(19) United States
(12) Patent Application Publication
(10) Pub. No.: US 2006/0055323 A1
(43) Pub. Date: Mar. 16, 2006

(54) Plasma display panel and flat lamp using boron nitride bamboo shoot

(76) Inventors: Hidekazu Hatanaka, Suwon-si (KR); Young-Mo Kim, Suwon-si (KR); Ho-Nyeon Loo, Suwon-si (KR); Seung-Hyun Son, Suwon-si (KR); Sang-Hun Jang, Suwon-si (KR); Seong-Eui Lee, Suwon-si (KR); Gi-Young Kim, Suwon-si (KR); Hyoung-Bin Park, Suwon-si (KR)

Correspondence Address: H.C. PARK & ASSOCIATES, PLC, 8500 LEESBURG PIKE, SUITE 7500, VIENNA, VA, 22182, US

(21) Appl. No.: 11/220,823

(22) Filed: Sep. 8, 2005

(30) Foreign Application Priority Data
Sep. 13, 2004 (KR) 10-2004-0073085

(51) Int. Cl. H01J 17/49

(52) U.S. Cl. 313/583; 313/584; 313/585

(57) ABSTRACT

A plasma display panel (PDP) and a flat lamp using a boron nitride bamboo shoot (BNBS). The PDP includes a front substrate and a rear substrate opposing each other and having a plurality of discharge cells between them, a plurality of address electrodes arranged on the rear substrate in parallel to each other, a plurality of sustain electrodes arranged on the front substrate in parallel to each other and crossing the address electrodes, a dielectric layer arranged on the sustain electrodes, and a plurality of secondary electron emission electrodes arranged on the dielectric layer in parallel to each other and corresponding to the sustain electrodes, respectively. The secondary electron emission electrodes include the BNBS.

### CROSS REFERENCE TO RELATED APPLICATION

This application claims priority to and the benefit of Korean Patent Application No. 10-2004-0073085, filed on Sep. 13, 2004, which is hereby incorporated by reference for all purposes as if fully set forth herein.

### BACKGROUND OF THE INVENTION

1. Field of the Invention

The present invention relates to a plasma display panel and a flat lamp, and more particularly, to a plasma display panel and a flat lamp using a boron nitride bamboo shoot (BNBS).

2. Discussion of the Background

FIG. 1A is a perspective view showing a general three-electrode surface discharge plasma display panel (PDP), and FIG. 1B and FIG. 1C are cross-sectional views showing the PDP of FIG. 1A cut in a width direction and a length direction, respectively. As shown in FIG. 1A, FIG. 1B and FIG. 1C, the PDP includes a front glass substrate 20 and a rear glass substrate 10 facing each other with a predetermined gap therebetween, barrier ribs 13 dividing a space between the front glass substrate 20 and the rear glass substrate 10 into discharge cells 21 corresponding to respective pixels, and an address electrode 11 and sustain electrodes 14 and 15 for discharging at each discharge cell 21. The sustain electrodes 14 and 15, which are transparent electrodes formed of a material such as indium tin oxide (ITO), make a pair for sustaining the discharge. A bus electrode 16 is formed on the sustain electrodes 14 and 15 to reduce a voltage drop due to the resistance of the transparent sustain electrodes. Additionally, a dielectric layer 18 covers the sustain electrodes 14 and 15, and a protective layer 19, which may be a MgO layer, covers and protects the dielectric layer 18. The pair of sustain electrodes 14 and 15 are disposed on the same plane and in parallel to each other to cross the address electrode 11 so that a surface discharge is generated to display an image. Here, reference numeral 12 denotes a dielectric layer, and 17 denotes a phosphor layer.

In the discharge cell 21 of the PDP having the above structure, the MgO protective layer 19 discharges secondary electrons into the discharge cell 21, thereby improving discharge efficiency and lowering a discharge voltage to be applied between the electrodes. Additionally, the MgO protective layer 19 protects the electrodes in the PDP. However, the MgO protective layer has a limited ability to emit secondary electrons into the discharge space.

Applicant's Korean Patent Application No. 2000-5648 (Feb. 7, 2000) discloses a “Secondary electron amplification structure applying carbon nanotube and plasma display panel using the same” for solving the above problem. FIG. 2 is a cross-sectional view showing the front glass substrate 20 of the PDP, which is disclosed in the above application, cut in parallel to the barrier rib. As shown in FIG. 2, carbon nanotubes (CNT) 22 are formed on the dielectric layer 18 before forming the MgO protective layer, and the MgO protective layer 19 is formed on the CNT 22. According to this structure, electrons are discharged through an end of the CNT 22, thereby improving efficiency of secondary electron emission into the discharge space.

However, the CNT 22 may be easily damaged from collisions with particles during discharge. Consequently, the PDP using the CNT 22 may not be very durable. Additionally, the CNT 22 generally has low light transmittance, which lowers the entire brightness of the PDP. That is, light generated by the phosphor layer should transmit through the front glass substrate 20, however, the CNT 22 blocks some of this light.

### SUMMARY OF THE INVENTION

The present invention provides a plasma display panel (PDP) and a flat lamp having improved durability and brightness and that may be driven with low voltage by improving secondary electron emission efficiency.

Additional features of the invention will be set forth in the description which follows, and in part will be apparent from the description, or may be learned by practice of the invention.

The present invention discloses a plasma display panel including a front substrate and a rear substrate opposing each other and having a plurality of discharge cells between them, a plurality of address electrodes arranged on the rear substrate substantially in parallel to each other, a plurality of sustain electrodes arranged on the front substrate substantially in parallel to each other and crossing the address electrodes, a dielectric layer arranged on the sustain electrodes, and a plurality of secondary electron emission electrodes arranged on the dielectric layer substantially in parallel to each other and corresponding to the sustain electrodes, respectively. A secondary electron emission electrode includes a boron nitride bamboo shoot (BNBS).

The present invention also discloses a plasma display panel including a front substrate and a rear substrate opposing each other and having a plurality of discharge cells between them, a plurality of address electrodes arranged on the rear substrate substantially in parallel to each other, a plurality of sustain electrodes arranged on the front substrate substantially in parallel to each other and crossing the address electrodes, a plurality of secondary electron emission electrodes arranged on the sustain electrodes, respectively, and a dielectric layer arranged on the sustain electrodes. A secondary electron emission electrode includes a BNBS.

The present invention also discloses a flat lamp including a first substrate and a second substrate opposing each other with a gap between them, a phosphor arranged on an inner surface of the second substrate, a plurality of sustain electrodes arranged on an inner surface of the first substrate substantially in parallel to each other, a dielectric layer arranged on the sustain electrodes, and a plurality of secondary electron emission electrodes arranged on the dielectric layer substantially in parallel to each other and corresponding to the sustain electrodes, respectively. A secondary electron emission electrode includes a BNBS.

The present invention also discloses a flat lamp including a first substrate and a second substrate opposing each other with a gap between them, a phosphor arranged on an inner surface of the second substrate, a plurality of sustain electrodes arranged on an inner surface of the first substrate substantially in parallel to each other, a plurality of secondary electron emission electrodes arranged on the sustain electrodes, respectively, and a dielectric layer arranged on the first substrate so as to cover side walls of the sustain electrodes and the secondary electron emission electrodes. A secondary electron emission electrode includes a BNBS.

The present invention also discloses a flat lamp including a first substrate and a second substrate opposing each other with a gap between them, a phosphor arranged on an inner surface of the second substrate, a plurality of sustain electrodes arranged on an outer surface of the first substrate substantially in parallel to each other, and a plurality of secondary electron emission electrodes arranged on an inner surface of the first substrate substantially in parallel to each other and corresponding to the sustain electrodes. A secondary electron emission electrode includes a BNBS.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1A is a perspective view showing a general three-electrode surface discharge plasma display panel (PDP).

FIG. 1B and FIG. 1C are cross-sectional views showing the PDP of FIG. 1A cut in a width direction and a length direction, respectively.

FIG. 2 is a schematic cross-sectional view showing a front substrate of a conventional PDP using carbon nanotubes (CNT).

FIG. 3 is a schematic cross-sectional view showing a front substrate of a PDP according to a first exemplary embodiment of the present invention.

FIG. 4 is a graph showing electric field-current characteristics of a boron nitride bamboo shoot (BNBS).

FIG. 5 is a schematic view showing a crystalline structure of the BNBS.

FIG. 6 is a schematic view showing a method of manufacturing the BNBS.

FIG. 7 is a microscope photograph showing the BNBS.

FIG. 8A and FIG. 8B are cross-sectional views showing modified embodiments of the PDP of FIG. 3.

FIG. 9 is a schematic cross-sectional view showing a front substrate of a PDP according to a second exemplary embodiment of the present invention.

FIG. 10A and FIG. 10B are cross-sectional view showing modified embodiments of the PDP of FIG. 9.

FIG. 11A, FIG. 11B, FIG. 11C and FIG. 11D are views showing a method of manufacturing a front substrate of a PDP in a case where nickel is used as a bottom electrode.

FIG. 12A, FIG. 12B, FIG. 12C and FIG. 12D are views showing a method of manufacturing the front substrate of the PDP in a case where silicon is used as the bottom electrode.

FIG. 13 is a schematic cross-sectional view showing a rear substrate of a PDP according to a third exemplary embodiment of the present invention.

FIG. 14 and FIG. 15 are cross-sectional views showing a structure of a flat lamp according to exemplary embodiments of the present invention.

FIG. 16A is a perspective view showing another example of a flat lamp according to an exemplary embodiment of the present invention.

FIG. 16B and FIG. 16C are cross-sectional views showing the flat lamp of FIG. 16A cut in width and length directions, respectively.

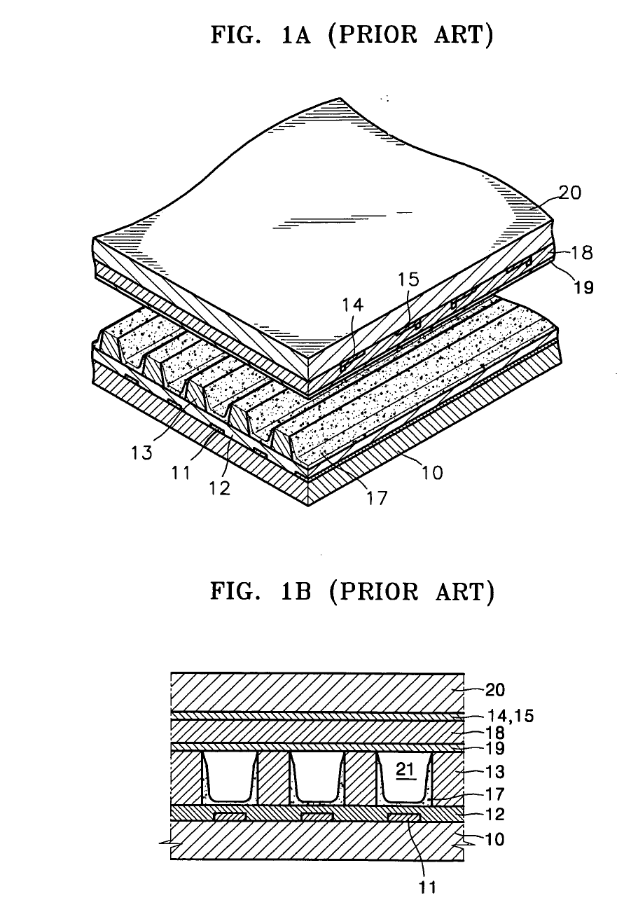

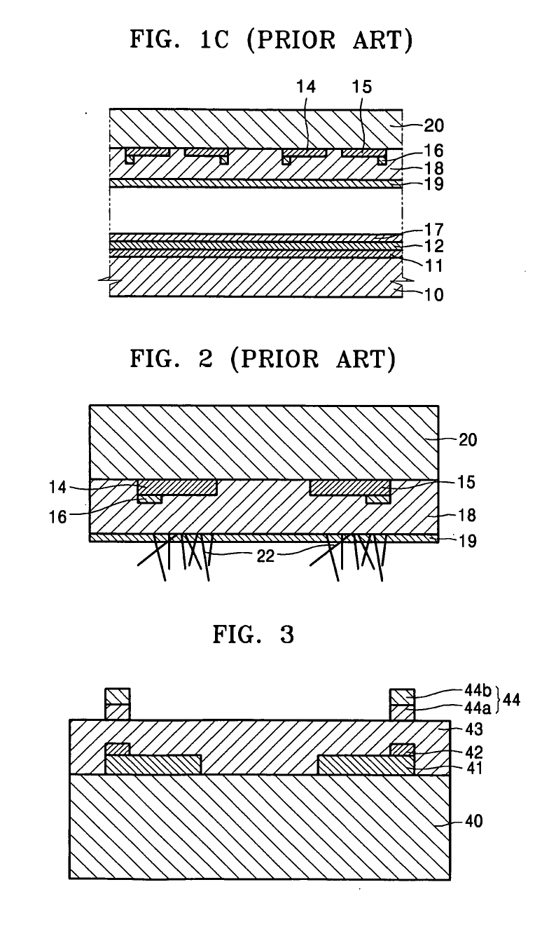

### DETAILED DESCRIPTION OF THE ILLUSTRATED EMBODIMENTS

FIG. 3 is a cross-sectional view showing a front substrate of a plasma display panel (PDP) according to an exemplary embodiment of the present invention. As FIG. 3 shows, a plurality of secondary electron emission electrodes 44 comprising boron nitride bamboo shoot (BNBS) are formed on a dielectric layer 43 in parallel to each other. Here, the secondary electron emission electrodes 44 are formed to face a sustain electrode 41 on a front substrate 40. More specifically, the secondary electron emission electrodes 44 face a bus electrode 42 that is formed on an upper surface of the sustain electrode 41. Additionally, the secondary electron emission electrodes 44 are formed as wide as the bus electrodes 42. As FIG. 3 shows, the secondary electron emission electrode 44 includes a bottom electrode layer 44a, which is formed on the dielectric layer 43, and a boron nitride bamboo shoot (BNBS) layer 44b, which is formed on the bottom electrode layer 44a. Therefore, the bottom electrode layer 44a functions as a substrate on which the BNBS layer 44b is formed, and it is formed of silicon (Si) or nickel (Ni). The Si may be amorphous or polycrystalline silicon.

Here, BNBS is a name of sp³ bonding 5H-BN, and it was developed by National Institute for Material Science (NIMS) of Japan and made public in March, 2004. BNBS is very hard, and it has a stable structure. Additionally, BNBS is transparent at a region of 380 to 780 nm wavelength, that is, visible ray region, and it has a negative electron affinity, thus it has a high electron emitting characteristic.

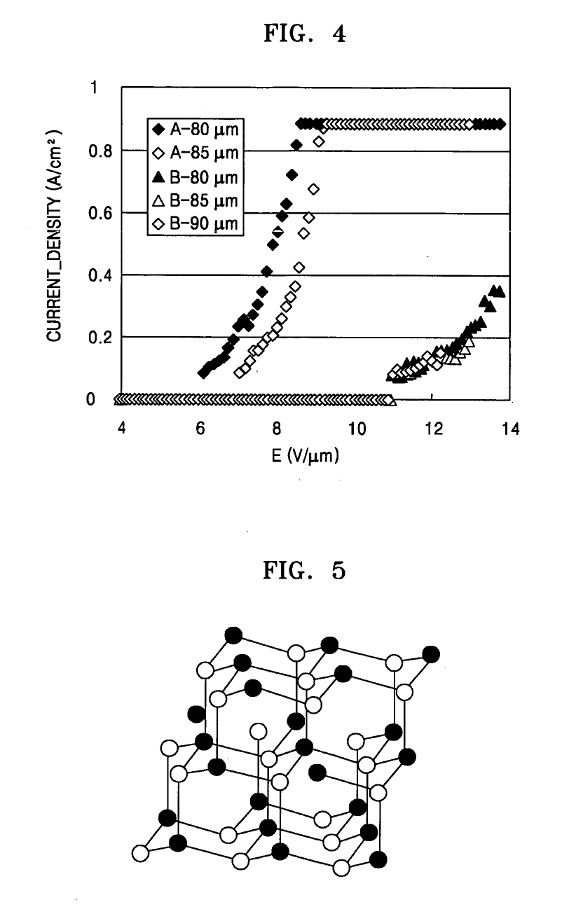

FIG. 4 is a graph showing electric field—current density characteristics of BNBS. In FIG. 4, the material denoted by A is BNBS, and the material denoted by B is carbon nanotube (CNT). As FIG. 4 shows, BNBS has a current density of about 0.9 A/cm² in an electric field of about 8.9V/μm. However, CNT has a current density of about 1 mA/cm² in an electric field of about 8.9V/μm. That is, BNBS has a current density that may be significantly greater than that of CNT at the same electric field. Therefore, BNBS has a higher electron emitting characteristic than that of CNT. Additionally, FIG. 5 shows a crystalline structure of BNBS. As FIG. 5 shows, boron nitride based material such as BNBS has a cubic crystalline structure. Therefore, boron nitride based material such as BNBS has a stable and firm characteristic similar to diamond (Handbook of refractory carbides and nitrides, Hugh O. Pierson, Noyes Publications, Table 13.6 p. 236, 1996).

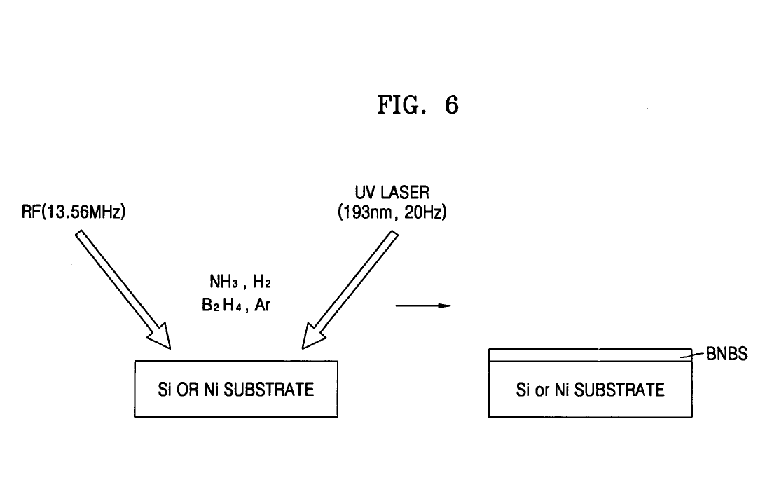

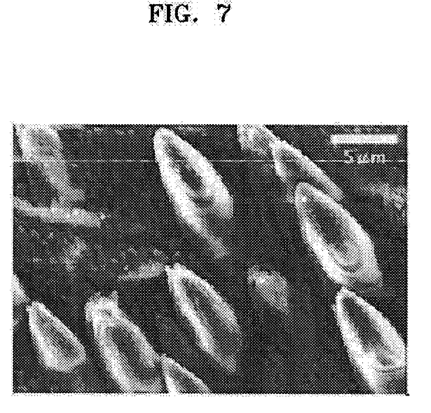

BNBS may be simply fabricated. FIG. 6 shows a method for fabricating BNBS. As FIG. 6 shows, in order to fabricate BNBS, a Si or Ni substrate is put into a chamber, which is filled of a mixed gas of NH₃, H₂, B₂H₄, and Ar, a 193 nm wavelength ultraviolet laser is scanned onto the Si or Ni substrate, and high frequency (about 13.56 Hz) is applied into the chamber to form BNBS on the Si or Ni substrate. FIG. 7 is a microscope photograph showing BNBS formed as described above. As FIG. 7 shows, an end portion of the BNBS is formed as a bamboo shoot. Hence, BNBS is named after the bamboo shoot shape.

The secondary electron emission electrodes 44 including the BNBS layer 44b may improve secondary electron emission efficiency, and discharges cause them minimal damage. Therefore, a PDP including the BNBS layer 44b to discharge secondary electrons may be more durable and brighter than a conventional PDP using CNT to discharge secondary electrons.

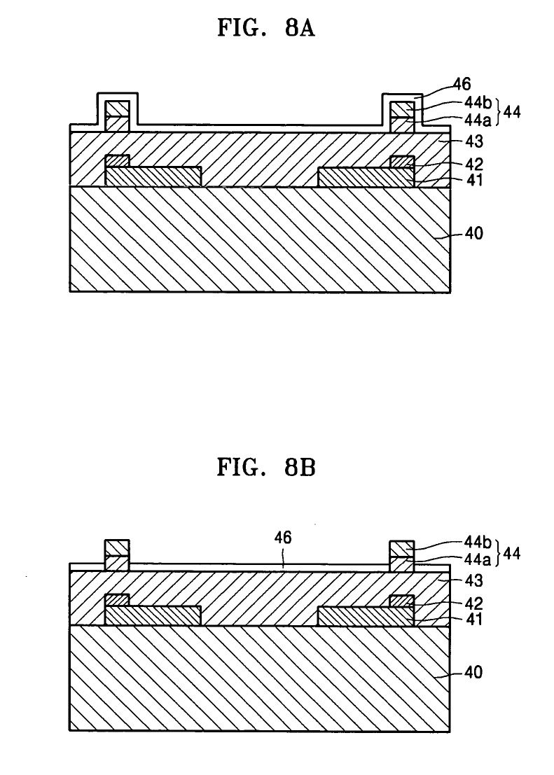

FIG. 8A and FIG. 8B are views showing modified examples of the PDP of FIG. 3. In FIG. 3, an additional layer is not formed on the dielectric layer 43. However, in the PDP of FIG. 8A, a protective layer 46 covers the dielectric layer 43 and the secondary electron emission electrodes 44. For example, the protective layer 46 may be formed of an MgO layer. As described above, an MgO protective layer increases discharge efficiency by emitting secondary electrons into the discharge cell. According to an embodiment of the present invention, since discharge efficiency may be sufficiently improved by the secondary electron emission electrodes 44, the MgO protective layer may be omitted, as shown in FIG. 3. However, the MgO protective layer 46 may also be applied to protect the dielectric layer 43, as shown in FIG. 8A. Additionally, as FIG. 8B shows, the MgO protective layer 46 may be formed on the dielectric layer 43 but not on the secondary electron emission electrodes 44.

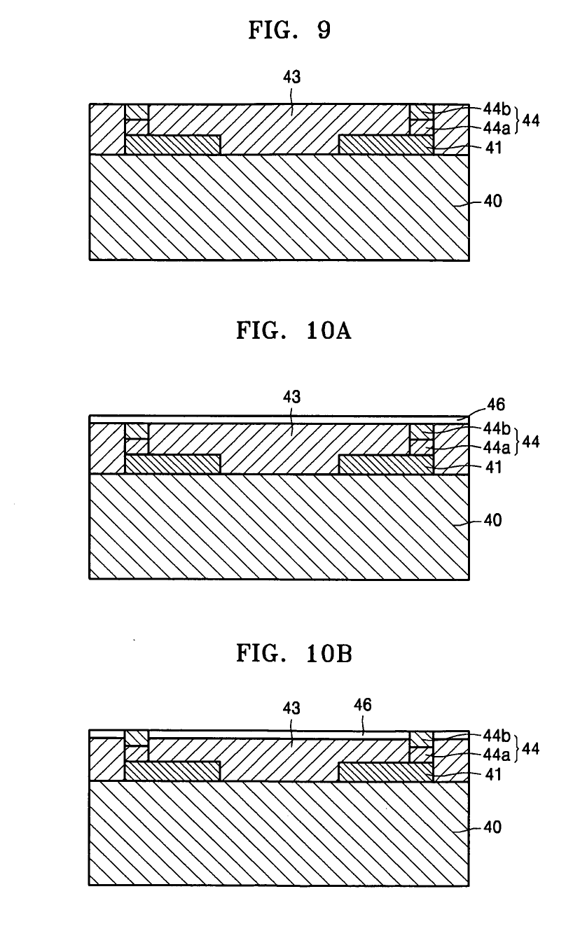

FIG. 9 is a schematic cross-sectional view showing a front substrate of a PDP according to the second exemplary embodiment of the present invention. As FIG. 9 shows, the bus electrode 42 of the first embodiment is omitted, and the secondary electron emission electrodes 44 are formed on the positions of the bus electrodes 42. In other words, the secondary electron emission electrodes 44 are formed on at least a part of the sustain electrodes 41, and they are arranged in parallel to the sustain electrodes 41. Therefore, the secondary electron emission electrodes 44 of the second embodiment simultaneously perform the function of bus electrodes and the function of secondary electron emission electrodes. The secondary electron emission electrodes 44 include the bottom electrode layer 44a formed of Si or Ni, and the BNBS layer 44b formed on the bottom electrode layer 44a. Additionally, as FIG. 9 shows, the dielectric layer 43 is applied on the front substrate 40 to cover the sustain electrodes 41 and side walls of the secondary electron emission electrodes 44. For example, the upper surface of the secondary electron emission electrodes 44 may be exposed in the discharge cell (not shown) by forming the height of the dielectric layer 43 to be same as the sum of heights of the sustain electrode 41 and the secondary electron emission electrode 44.

FIG. 10A and FIG. 10B are views showing modified examples of the PDP according to the second embodiment of FIG. 9. In FIG. 10A, the MgO protective layer 46 is applied on an upper surface of the dielectric layer 43 and an upper surface of the secondary electron emission electrode 44. As described above, the MgO protective layer 46 prevents the dielectric layer 43 from being physically and chemically damaged, and it emits secondary electrons. Additionally, since the secondary electron emission electrode 44 comprising the BNBS layer 44b is durable and efficient, the MgO protective layer 46 may be formed only on the dielectric layer 43, as FIG. 10B shows. In this case, the dielectric layer 43 is formed slightly lower than the sum of the heights of the sustain electrode 41 and the secondary electron emission electrode 44. Additionally, a thin MgO protective layer 46 is formed on the upper surface of the dielectric layer 43 but not on the secondary electron emission electrode 44. Thus, the secondary electron emission electrodes 44 are exposed in the discharge cell. Here, the MgO protective layer 46 is about 5,000 Å thick.

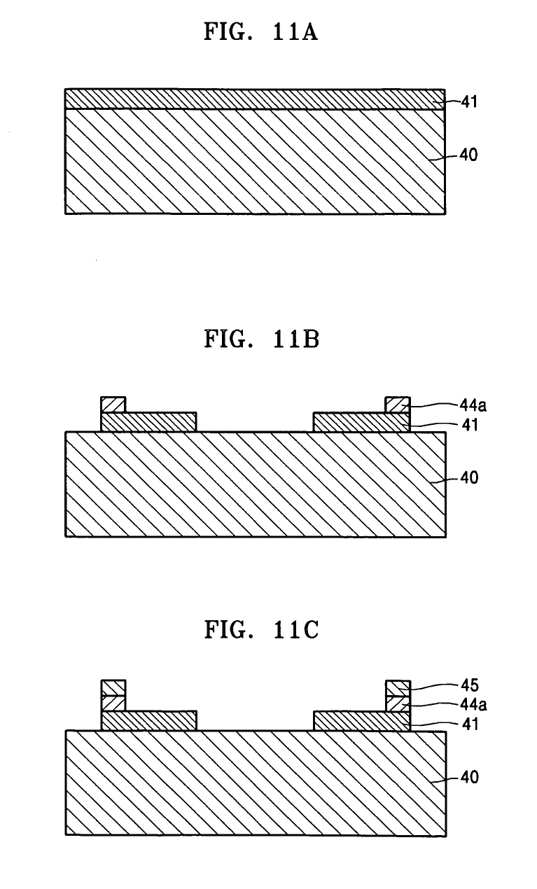

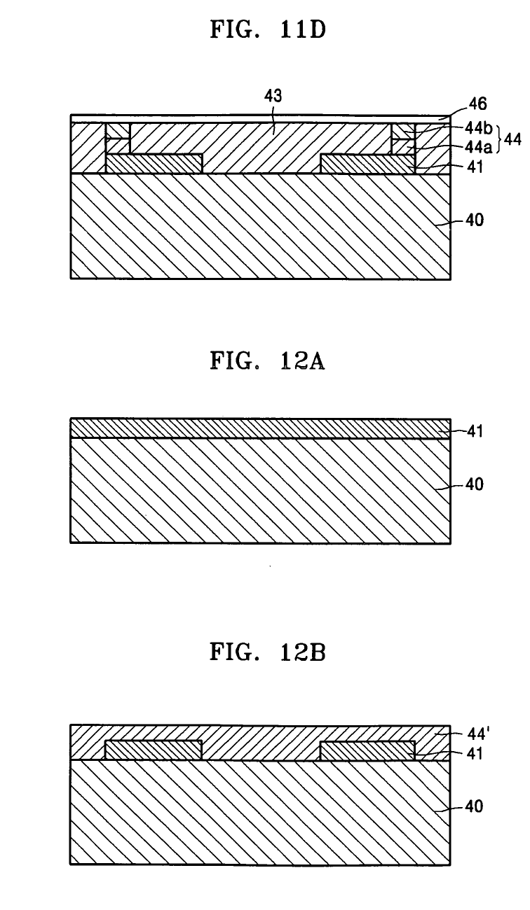

FIG. 11A, FIG. 11B, FIG. 11C and FIG. 11D illustrate a method of manufacturing the front substrate of the PDP according to an embodiment of the present invention when using Ni as the bottom electrode 44s of the secondary electron emission electrode 44. As FIG. 11A shows, a transparent metal material such as an indium tin oxide (ITO) is deposited on a general glass substrate 40 such as soda-line glass. The deposited transparent metal is then patterned to form the sustain electrode 41, and Ni is partially deposited on the sustain electrode 41 in the general deposition method as shown in FIG. 11B. As described above, the nickel functions as a bottom electrode layer 44a for forming the BNBS layer 44b. Additionally, as FIG. 11C shows, the glass substrate 40, on which the sustain electrode 41 and the bottom electrode 44a are formed, is put into a chamber that is filled of a mixed gas including NH₃, H₂, B₂H₄, and Ar, and the BNBS layer 44b is formed on the bottom electrode layer 44a using laser-plasma enhanced chemical vapor deposition (LA-PECVD). Then, as FIG. 11D shows, the dielectric layer 43 is formed on the glass substrate 40 so as to surround side walls of the bottom electrode layer 44s and the BNBS layer 44b. The MgO protective layer 46 may be additionally formed on the dielectric layer 43.

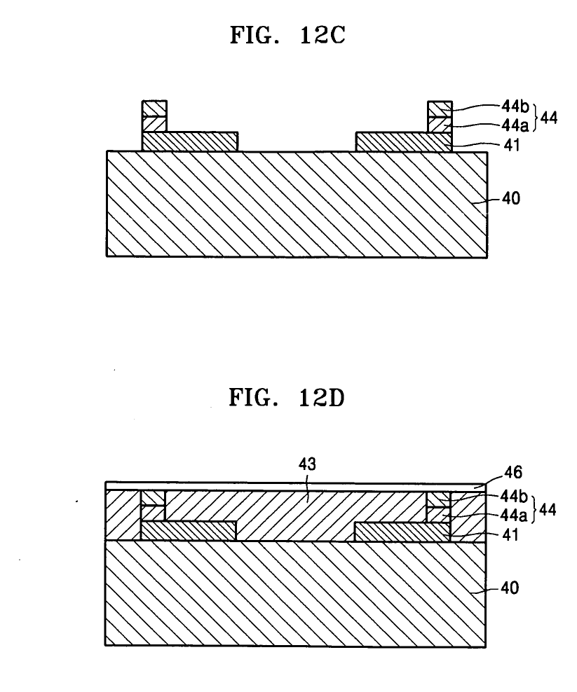

FIG. 12A, FIG. 12B, FIG. 12C and FIG. 12D illustrate a method of manufacturing the front substrate of the PDP according to the second embodiment of the present invention when using Si as the bottom electrode 44a of the secondary electron emission electrode 44. As FIG. 12A shows, a transparent metal material such as the ITO is deposited on a general glass substrate 40 such as soda-line glass. The deposited transparent metal is then patterned to form the sustain electrode 41, and about 1.51 μm thick polycrystalline silicon (poly-Si) layer 44′ is formed on the glass substrate 40 and the sustain electrode 41, as shown in FIG. 12B. The poly-Si layer 44′ may be formed by depositing amorphous silicon using PECVD at a temperature less than 400° C. and then crystallizing the a-Si using a crystallization method such as sequential lateral solidification, metal induced crystallization, metal induced lateral crystallization, or other crystallization methods. Next, as FIG. 12C shows, the poly-Si layer 44′ is patterned to form the bottom electrode 44a, and the BNBS layer 44b is then formed on the bottom electrode 44a using the LA-PECVD method. Additionally, as FIG. 12D shows, the dielectric layer 43 is formed on the glass substrate 40 so as to surround the side walls of the bottom electrode layer 44a and the BNBS layer 44b. The MgO protective layer 46 may be additionally formed on the dielectric layer 43.

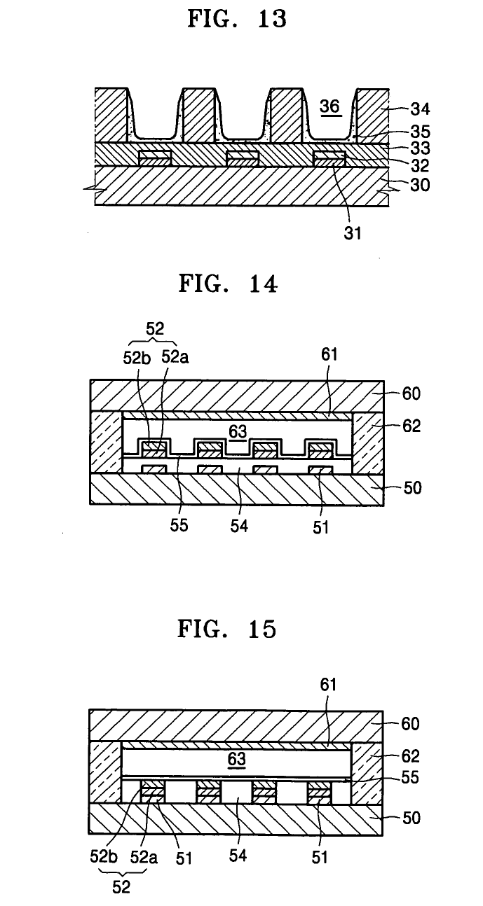

In the above embodiments, the secondary electron emission electrode is formed on the sustain electrode of the front substrate, however, the secondary electron emission electrode may also be formed on an address electrode of a rear substrate. FIG. 13 is a cross-sectional view showing a rear substrate of a PDP, in which the secondary electron emission electrode is formed on the address electrode, according to a third exemplary embodiment of the present invention. As FIG. 13 shows, the rear substrate unit of the PDP according to the third embodiment of the present invention includes a rear substrate 30 that is formed of a transparent material such as a glass, a plurality of address electrodes 31 formed on the rear substrate 30 in parallel to each other, a secondary electron emission electrode 32 formed on the address electrode 31, a dielectric layer 33 covering the address electrodes 31 and the secondary electron emission electrodes 32, a plurality of barrier ribs 34 disposed on the dielectric layer 33 and dividing a space between the rear substrate 30 and the front substrate 40 into a plurality of discharge cells 36, and a phosphor 35 applied on inner walls of the discharge cells 36. As described above, when the secondary electron emission electrode 32 is formed on the address electrode 31, the address discharge voltage may be reduced in the discharge cell 36 and discharge efficiency may be improved. Here, the secondary electron emission electrode 32 comprises a BNBS layer. The address electrode 31 may be formed of poly-Si or Ni so that the BNBS layer may be formed on the address electrode 31. Alternatively, the address electrode 31 may be formed using a metal such as Al, and the secondary electron emission electrode 32 may be formed having a two-layer structure. In this case, the bottom electrode layer may be formed of poly-Si or Ni, and the BNBS layer may be formed on the bottom electrode layer, which is formed on the address electrode 31.

The secondary electron emission electrode according to embodiments of the present invention may be applied to a flat lamp that may be used as a back light for a liquid crystal display (LCD), since a base structure and operational principle of the flat lamp are the same as those of the PDP. That is, the flat lamp also has a structure in which discharge gas is injected between two glass substrates, and ultraviolet rays generated by gas discharge excite phosphors to emit visible rays.

FIG. 14 is a cross-sectional view showing a structure of a flat lamp according to an embodiment of the present invention. As FIG. 14 shows, the flat lamp includes a front substrate 50 and a rear substrate 60 opposing each other with a predetermined gap therebetween to form a discharge space 63, a phosphor 61 applied on the rear substrate 60, a plurality of sustain electrodes 51 formed on the front substrate 50 in parallel to each other for making a discharge in the discharge space 63, a dielectric layer 54 applied on the front substrate 50 to cover the sustain electrodes 51, and a plurality of secondary electron emission electrodes 52 formed on the dielectric layer 54 in parallel to each other and corresponding to the sustain electrodes 51. Additionally, a barrier rib 62 seals the discharge space 63. Here, the secondary electron emission electrodes 52 include a BNBS layer 52b for emitting secondary electrons and a bottom electrode layer 52a, which is formed on the dielectric layer 54 and functions as a substrate on which the BNBS layer 52b is formed. The bottom electrode layer 52a may comprise Si or Ni. Therefore, the front substrate of the flat lamp of FIG. 14 has the nearly same structure as that of the front substrate of the PDP of FIG. 3.

Additionally, as shown in the modified example of the PDP of FIG. 8A and FIG. 8B, an MgO protective layer 55 may be applied on the upper surface of the dielectric layer 54 and the upper surface of the secondary electron emission electrodes 52 in order to protect the dielectric layer 54 in the flat lamp of FIG. 14. The MgO protective layer 55 prevents the dielectric layer 54 from being physically and chemically damaged, and it emits secondary electrons. Alternatively, the MgO protective layer 55 may be formed only on the dielectric layer 54. In this case, the secondary electron emission electrodes 52 are exposed in the discharge space 63.

FIG. 15 is a cross-sectional view showing another example of a flat lamp according to an embodiment of the present invention. As FIG. 15 shows, the flat lamp includes the front substrate 50 and the rear substrate 60 opposing each other with a predetermined gap therebetween to form the discharge space 63, the phosphor 61 applied on the rear substrate 60, a plurality of sustain electrodes 51 formed on the front substrate 50 in parallel to each other for making a discharge in the discharge space 63, a plurality of secondary electron emission electrodes 52 formed on the upper surfaces of the sustain electrodes 51 in parallel to each other, and the dielectric layer 54 applied on the front substrate 50 in between, and as high as, a top surface of the secondary electron emission electrodes 52. Additionally, the barrier rib 62 seals the discharge space. As described above, the secondary electron emission electrodes 52 include the BNBS layer 52b and the bottom electrode layer 52a. Therefore, the front substrate of the flat lamp of FIG. 15 has a similar structure to that of the front substrate of the PDP of FIG. 9.

Additionally, in the flat lamp of FIG. 15, the MgO protective layer 55 may be applied on the upper surface of the dielectric layer 54 and the upper surfaces of the secondary electron emission electrodes 52 to protect the dielectric layer 54, like in the PDP of FIG. 10A. Alternatively, the MgO protective layer 55 may be formed only on the dielectric layer 54, like the modified embodiment of FIG. 10B.

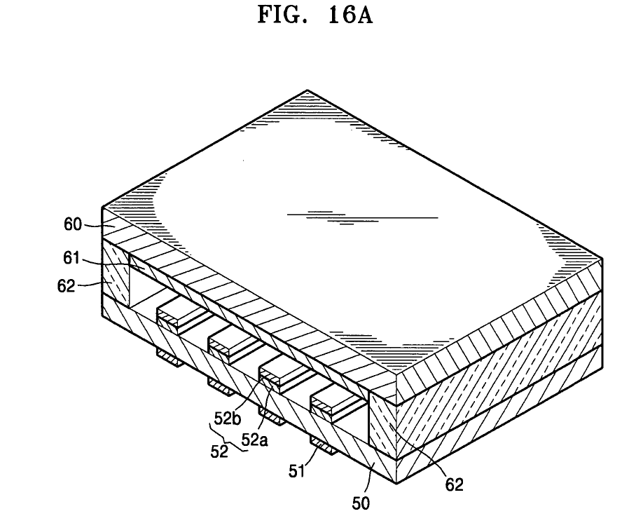

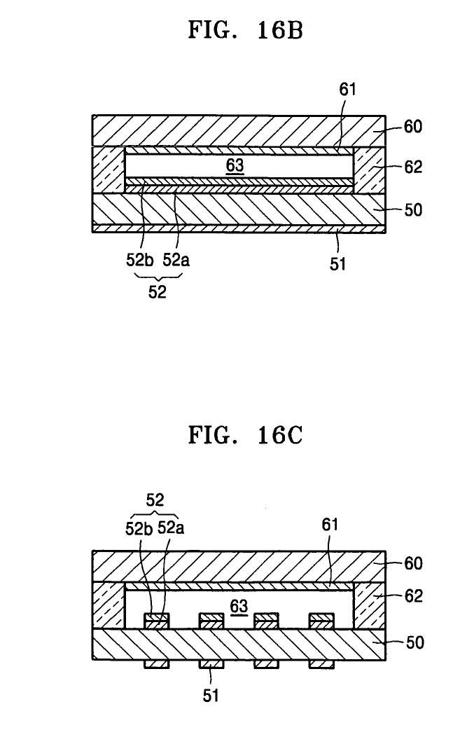

FIG. 16A is a perspective view showing another modified example of the flat lamp according to an embodiment of the present invention, and FIG. 16B and FIG. 16C are cross-sectional views showing the flat lamp of FIG. 16A cut in a transverse direction and a length direction, respectively. The flat lamp of FIG. 16A, FIG. 16B and FIG. 16C includes the front substrate 50 and the rear substrate 60 opposing each other with a predetermined gap therebetween to form the discharge space 63, the phosphor 61 applied on the rear substrate 60, a plurality of sustain electrodes 51 formed on a first surface of the front substrate 50 in parallel to each other for making a discharge in the discharge space 63, and a plurality of secondary electron emission electrodes 52 formed on a second surface of the front substrate 50 in parallel to each other. More specifically, the sustain electrodes 51 and the secondary electron emission electrodes 52 are formed to face each other on outer and inner surfaces of the front substrate 50, respectively.

In the flat lamp of FIG. 14 and FIG. 15, the sustain electrodes 51 are formed in the discharge space 63, however, in the flat lamp of FIGS. 16A through 16C, the sustain electrodes 51 are formed outside the discharge space 63. In this case, the front substrate 50 can replace the functions of the dielectric layer, thereby simplifying the flat lamp's structure. Additionally, since the dielectric layer is omitted, the MgO protective layer, which protects the dielectric layer, can also be omitted. Further, as described above, the secondary electron emission electrodes 52 include the BNBS layer 52b and the bottom electrode layer 52a. Since the secondary electron emission electrode comprises the BNBS layer, the flat lamp may be brighter and have a longer life span.

In the flat lamps described above, the sustain electrodes are formed on the front substrate, however, the description is an example, and the sustain electrodes may be formed on the rear substrate.

As described above, according to PDPs and flat lamps of the present invention, BNBS, which is a very hard material, is used to emit secondary electrons. Thus, the PDPs and the flat lamps may have superior durability and a longer life span than conventional PDPs and flat lamps using carbon nanotubes.

Additionally, since BNBS transmits light at the visible ray region, light generated from the phosphor may transmit through the front glass substrate without any substantial loss. Therefore, PDPs and flat lamps of the present invention may be brighter than conventional PDPs and flat lamps.

The BNBS has a low threshold voltage for performing the discharge operation. Thus, PDPs and flat lamps according to the present invention may be driven with lower voltage, which decreases power consumption.

Moreover, BNBS may be simply fabricated. Therefore, PDPs and flat lamps including BNBS may be fabricated in a shorter processing time and at lower fabricating costs than such devices including carbon nanotubes.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A plasma display panel, comprising:
a front substrate and a rear substrate opposing each other and having a plurality of discharge cells between them;
a plurality of address electrodes arranged on the rear substrate substantially in parallel to each other;
a plurality of sustain electrodes arranged on the front substrate substantially in parallel to each other and crossing the address electrodes;
a dielectric layer arranged on the sustain electrodes; and
a plurality of secondary electron emission electrodes arranged on the dielectric layer substantially in parallel to each other and corresponding to the sustain electrodes, respectively,
wherein a secondary electron emission electrode includes a boron nitride bamboo shoot (BNBS).

2. The plasma display panel of claim 1, wherein the secondary electron emission electrode comprises a bottom electrode layer arranged on the dielectric layer and a BNBS layer arranged on the bottom electrode layer.

3. The plasma display panel of claim 2, wherein the bottom electrode layer comprises silicon or nickel.

4. The plasma display panel of claim 1, further comprising an MgO protective layer arranged on the secondary electron emission electrodes and the dielectric layer.

5. The plasma display panel of claim 1, further comprising an MgO protective layer arranged on the dielectric layer except where the secondary electron emission electrodes are arranged.

6. The plasma display panel of claim 1, further comprising a plurality of bus electrodes arranged on the sustain electrodes.

7. The plasma display panel of claim 6, wherein the secondary electron emission electrodes are arranged corresponding to the bus electrodes and have the same width as the bus electrodes.

8. The plasma display panel of claim 1, further comprising a plurality of secondary electron emission electrodes arranged on the address electrodes, respectively,
wherein the secondary electron emission electrodes arranged on the address electrodes include the BNBS.

9. The plasma display panel of claim 8, wherein the secondary electron emission electrodes arranged on the address electrodes comprise a bottom electrode layer arranged on the address electrode and a BNBS layer arranged on the bottom electrode layer.

10. A plasma display panel, comprising:
a front substrate and a rear substrate opposing each other and having a plurality of discharge cells between them;
a plurality of address electrodes arranged on the rear substrate substantially in parallel to each other;
a plurality of sustain electrodes arranged on the front substrate substantially in parallel to each other and crossing the address electrodes;
a plurality of secondary electron emission electrodes arranged on the sustain electrodes, respectively; and
a dielectric layer arranged on the sustain electrodes,
wherein a secondary electron emission electrode includes a boron nitride bamboo shoot (BNBS).

11. The plasma display panel of claim 10, wherein the secondary electron emission electrode comprises a bottom electrode layer arranged on a sustain electrode and a BNBS layer arranged on the bottom electrode layer.

12. The plasma display panel of claim 11, wherein the bottom electrode layer comprises silicon or nickel.

13. The plasma display panel of claim 10, further comprising an MgO protective layer arranged on the secondary electron emission electrodes and the dielectric layer.

14. The plasma display panel of claim 10, further comprising an MgO protective layer arranged on the dielectric layer but not on the secondary electron emission electrodes.

15. The plasma display panel of claim 10, further comprising a plurality of secondary electron emission electrodes arranged on the address electrodes, respectively,
wherein the secondary electron emission electrodes arranged on the address electrodes include the BNBS.

16. The plasma display panel of claim 15, wherein the secondary electron emission electrodes arranged on the address electrodes comprise a bottom electrode layer arranged on the address electrode and a BNBS layer arranged on the bottom electrode layer.

17. A flat lamp, comprising:
a first substrate and a second substrate opposing each other with a gap between them;
a phosphor arranged on an inner surface of the second substrate;
a plurality of sustain electrodes arranged on an inner surface of the first substrate substantially in parallel to each other;
a dielectric layer arranged on the sustain electrodes; and
a plurality of secondary electron emission electrodes arranged on the dielectric layer substantially in parallel to each other and corresponding to the sustain electrodes, respectively,
wherein a secondary electron emission electrode includes a boron nitride bamboo shoot (BNBS).

18. The flat lamp of claim 17, wherein the secondary electron emission electrode comprises a bottom electrode layer arranged on the dielectric layer and a BNBS layer arranged on the bottom electrode layer.

19. The flat lamp of claim 18, wherein the bottom electrode layer comprises silicon or nickel.

20. The flat lamp of claim 17, further comprising an MgO protective layer arranged on the secondary electron emission electrodes and the dielectric layer.

21. The flat lamp of claim 17, further comprising an MgO protective layer arranged on the dielectric layer except where the secondary electron emission electrodes are arranged.

22. A flat lamp, comprising:
a first substrate and a second substrate opposing each other with a gap between them;
a phosphor arranged on an inner surface of the second substrate;
a plurality of sustain electrodes arranged on an inner surface of the first substrate substantially in parallel to each other;
a plurality of secondary electron emission electrodes arranged on the sustain electrodes, respectively; and
a dielectric layer arranged on the first substrate so as to cover side walls of the sustain electrodes and the secondary electron emission electrodes,
wherein a secondary electron emission electrode includes a boron nitride bamboo shoot (BNBS).

23. The flat lamp of claim 22, wherein the secondary electron emission electrode comprises a bottom electrode layer arranged on a sustain electrode and a BNBS layer arranged on the bottom electrode layer.

24. The flat lamp of claim 23, wherein the bottom electrode layer comprises silicon or nickel.

25. The flat lamp of claim 22, further comprising an MgO protective layer arranged on the secondary electron emission electrodes and the dielectric layer.

26. The flat lamp of claim 22, further comprising an MgO protective layer arranged on the dielectric layer but not on the secondary electron emission electrodes.

27. A flat lamp, comprising:
a first substrate and a second substrate opposing each other with a gap between them;
a phosphor arranged on an inner surface of the second substrate;
a plurality of sustain electrodes arranged on an outer surface of the first substrate substantially in parallel to each other; and
a plurality of secondary electron emission electrodes arranged on an inner surface of the first substrate substantially in parallel to each other and corresponding to the sustain electrodes,
wherein a secondary electron emission electrode includes a boron nitride bamboo shoot (BNBS).

28. The flat lamp of claim 27, wherein the secondary electron emission electrode comprises a bottom electrode layer arranged on the inner surface of the first substrate and a BNBS layer arranged on the bottom electrode layer.

29. The flat lamp of claim 28, wherein the bottom electrode layer comprises silicon or nickel.
